(19) United States
(12) Patent Application Publication
(10) Pub. No.: US 2014/0290880 A1
(43) Pub. Date: Oct. 2, 2014

(54) Removable Window and Door Screens

(71) Applicant: Joseph A. Altieri, JR., Pittsburgh, PA (US)

(72) Inventor: Joseph A. Altieri, JR., Pittsburgh, PA (US)

(21) Appl. No.: 13/853,632

(22) Filed: Mar. 29, 2013

(51) Int. Cl. E06B 9/24

(52) U.S. Cl. CPC E06B 9/24
USPC 160/369

(57) ABSTRACT

Screens are disclosed which are adapted to be retained within two parallel receiving grooves of a door or window opening. The screens have a frame which forms an aperture and a mesh material, the mesh material being fixedly attached to the frame so as cover the aperture. The frame has a pair of side members each of which is adapted to be received within a respective one of the receiving grooves. At least one of the side members is made of an elastic material and has a transverse width-to-thickness ratio of no more than about 1.5.

### BACKGROUND

1. Field of the Invention

The invention relates to window and door screens adapted to fit within parallel tracks of the opening of the window or door.

2. Background of the Art

Screens have been used for thousands of years for keeping insects, leaves, birds, and debris from entering a building or other structure while permitting the inflow of fresh air. In ancient times, cloth or wicker attached to a frame was used to make the screen. Modernly, most screens consist of a fiberglass mesh or netting held taut and supported by an aluminum frame. Other common mesh materials include nylon, polyester, bronze, stainless steel, aluminum, copper, brass, and galvanized steel. Other common frame materials include wood, steel, and vinyl, sometimes in combination with each other and/or aluminum, though over the years other materials have been tried, including rubber, fiberglass, and closed-cell foams. Some screens have no frames, but are mesh material that is made to roll out from a spool and then be held taut across an opening by fastening the mesh material to door or window itself.

Despite the maturity of the art of screen making, some improvements are still needed. One of those needed improvements relates to a type of screen which is in common use in modern residential and commercial construction. This screen type is referred to herein as a “groove-attachment screen.” The groove-attachment screen is held in place in the door or window opening in which it is intended to be used by way of parallel sides of its frame fitting within receiving grooves running along two parallel sides of the door or window opening. One or more springs typically project from one of the two vertical sides of the screen frame. In some cases, the receiving grooves are located on the vertical sides of the window or door opening, while in others they are located on the top and bottom sides of the window or door opening. Typically, one of the receiving grooves is a full-groove, i.e., a u-shaped groove, while the other receiving groove may be either a full groove or an a partial groove i.e., a groove having a bottom seating side and either just one retaining wall side or two retaining wall sides of unequal height.

During installation of a conventional groove-attachment screen, the side of the screen frame which has the spring or springs extending from it is angled into one of the receiving grooves of the door or window opening. The body of the screen then is rotated into the plane defined by the receiving grooves while the screen frame side having the spring or springs is pressed into its receiving groove to compress its attached spring or springs. This compression allows the opposite screen frame side to slip past the lip of its receiving groove. Once it does, the person installing the frame stops pressing against the spring side of the screen frame so that the spring or springs release some of their tension and cause the opposite side of the spring frame to seat against the bottom of its receiving groove. The screen is removed by reversing the installation process, i.e., by pressing the spring side of the screen frame into its receiving groove to unseat the opposite side of the screen frame while rotating the screen body so that the unseated screen frame side passes the lip of its receiving groove, and then withdrawing the spring side of the screen frame out of its receiving groove.

One problem with the conventional groove-attachment screen is that it can be difficult to install and to remove from the receiving grooves of window or door opening. This is especially true for difficult to reach windows and for large window or door openings since in such cases it is difficult to simultaneously compress all of the retaining springs along one side of the screen frame while fitting or withdrawing the opposing side of the screen frame into or out of its receiving groove. This problem is often aggravated when the corners or the frame members lack sufficient rigidity to maintain the frame in a single plane, the sides of the frame in alignment with one another, or the corners in their use-angles (which are usually right angles). Another problem with the conventional groove-attachment screen is that its frame sides which are retained in the receiving grooves are wider than the depths of their respective receiving grooves. This makes the sides visible to a viewer looking at the screen with a line of vision that is perpendicular to the screen's mesh material surface, thus raising aesthetic issues with the appearance of those sides of the frame.

Some solutions applicable to one or more of these problems may be found in the following U. S. patents: U.S. Pat. No. 246,153 to Koch; U.S. Pat. No. 1,736,688 to Yerby et al.; U.S. Pat. No. 1,756,227 to Torrent; and U.S. Pat. No. 6,484,789 to Ober. However, none of these prior art solutions is the same as that provided by the present invention nor are those prior art solutions as elegant as that provided by the present invention.

### SUMMARY OF THE PRESENT INVENTION

The present invention provides an improved groove-attachment screen which solves one or more of the problems described above with regard to conventional groove-attachment screens. Each of the inventive groove-attachment screens comprises a mesh material which is fixedly attached to a flexible frame that is adapted to be retained by a set of parallel receiving grooves of a door or window opening without the need for external springs attached to either the screen frame or the sides of the window or door opening. In some embodiments of the present invention, the width of at least one of the frame side members is less than the depth of the its corresponding receiving groove so that the side member is not visible to an observer who is viewing the screen with a line of vision that is perpendicular to the screen's mesh material surface.

Each of the screens of the present invention comprises a frame which forms an aperture and a mesh material that is fixedly attached to the frame so as cover the aperture. The frame includes a pair of side members each of which is adapted to be received within a respective one of a pair of receiving grooves of a window or door opening At least one of these side members is made from a stiff elastic material with a transverse cross-section having a width-to-thickness ratio of no greater than about 1.5, and preferably no greater than about 1, where the width is measured in the principal plane of the screen. Preferably, such a side member is adapted to bow sufficiently into the aperture when a perpendicular outwardly-directed force is applied against the mesh material adjacent to the side member to permit the side member to be grasped by a person's hand and to bow further into the aperture upon the application of a lateral force to the side member to allow the side member to be removed from its respective receiving groove. In some embodiments, one or more tabs are attached to such a side member so that the tab or tabs are capable of being grasped by a user's hand to urge that side member in the direction of the aperture.

### BRIEF DESCRIPTION OF THE DRAWINGS

The criticality of the features and merits of the present invention will be better understood by reference to the attached drawings. It is to be understood, however, that the drawings are designed for the purpose of illustration only and not as definitions of the limits of the present invention.

FIG. 1 is a perspective view of a groove-attachment screen according to an embodiment of the present invention.

FIG. 2 is a transverse cross-sectional view of a side member of the screen of FIG. 1.

FIG. 3 is an elevational view of another groove-attachment screen according to an embodiment of the present invention in which a pair of parallel receiving grooves of a door or window opening are depicted in phantom.

FIG. 4 is a cross-sectional view of a portion of the screen of FIG. 2 within a receiving groove.

### DESCRIPTION OF PREFERRED EMBODIMENTS

In this section, some preferred embodiments of the present invention are described in detail sufficient for one skilled in the art to practice the present invention. It is to be understood, however, that the fact that a limited number of preferred embodiments are described herein does not in any way limit the scope of the present invention as set forth in the appended claims.

Whenever the term “about” is used herein or in the appended claims to modify a feature of an embodiment of the present invention, it is to be construed as referring to the ordinary tolerances related to making and/or measuring the relevant feature. Whenever a range is used herein or in the appended claims to describe a feature of an embodiment of the present invention, the range is to be construed as including the stated or implied end points of the range and every point therebetween.

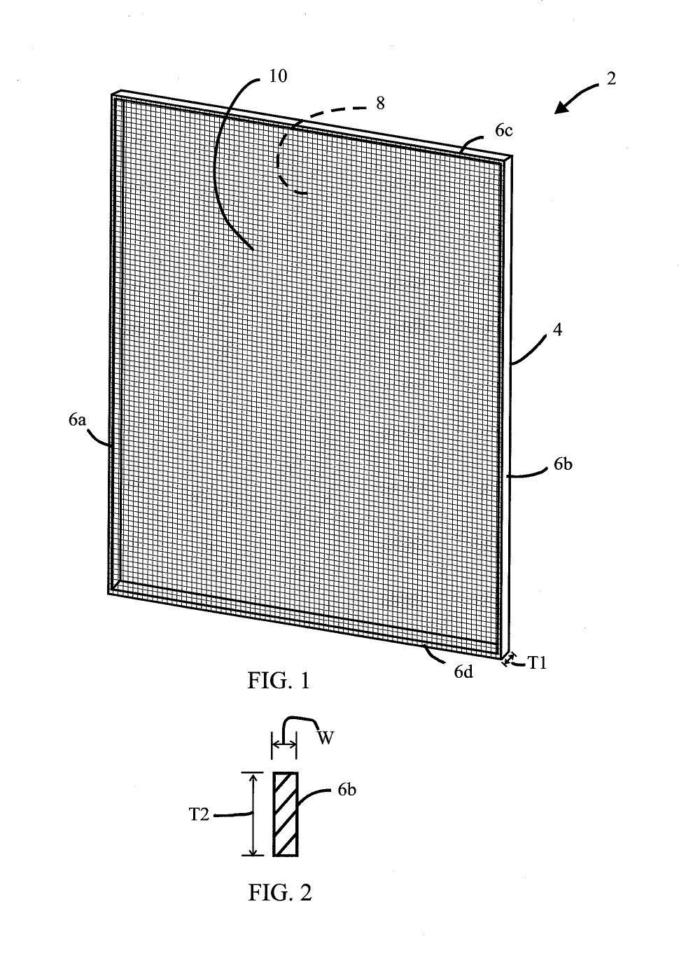

Referring to FIG. 1, there is shown a perspective view of a groove-attachment screen 2 according to an embodiment of the present invention. The screen 2 has a frame 4 having four side members 6a-6d which form an aperture 8 therebetween. The screen 2 also has a mesh material 10 that is fixedly attached to the frame 4 so as to cover aperture 8. The screen 2 has an overall thickness T1, which includes the thickness of the relevant side member 6a-6d and the mesh material 10.

A transverse cross-sectional view of side member 6b is shown in FIG. 2. The side member 6b has a width W and a thickness T2. It is to be understood that the thickness of the side members, e.g. thickness T2, is measured perpendicular to the plane defined by the mesh material 10 and the width of the side members, e.g., width W, is measured parallel to the plane defined by the mesh material 10.

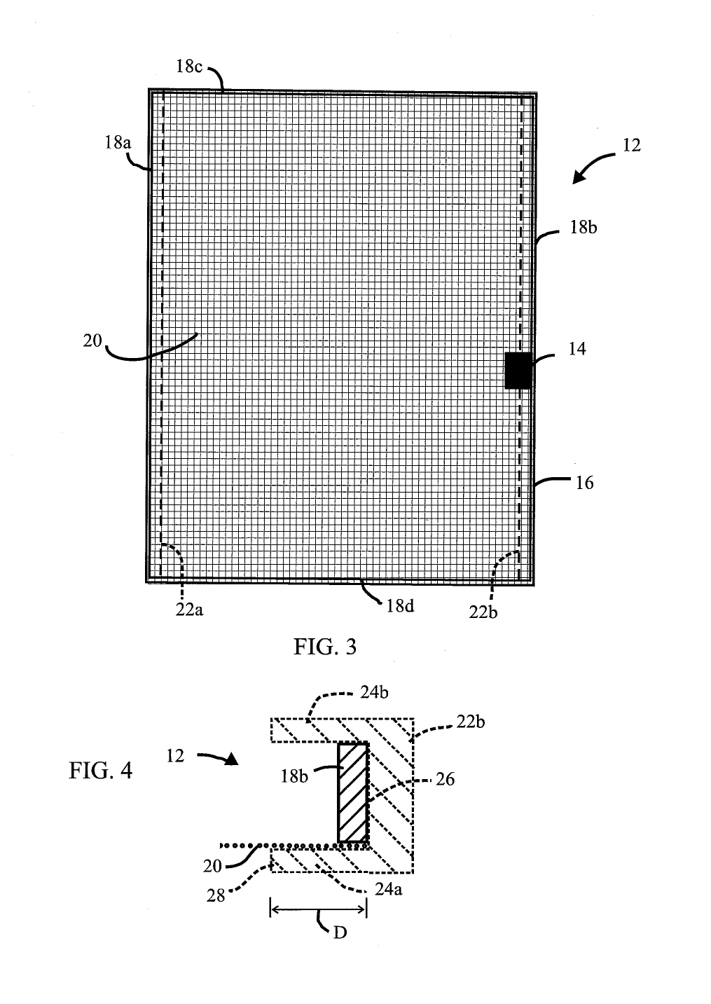

Referring now to FIG. 3, there is shown an elevational view of the screen 12 which is similar to screen 2 except that screen 12 has an optional tab 14 attached to its frame 16. The frame 16 includes the four side members 18a-18d. The screen 12 also comprises a mesh material 20 which is fixedly attached to the frame 16. Superimposed upon screen 12 are pair of dashed lines which represent the outer lips of two parallel receiving grooves 22a, 22b of a door or window opening by which screen 12 is retained the opening. Note that although the dashed lines seem to imply that the receiving grooves 22a, 22b are vertically disposed, this is not the case as they may take on any physical orientation.

Referring to FIG. 4, there is shown cross-sectional view of a portion of the screen 12 seated within the receiving groove 22b. The receiving groove 22b is a full groove and includes first and second retaining walls 24a, 24b and a bottom or seating surface 26. The depth D of the receiving groove 22b is the distance between the lip 28 of the first retaining wall 24a and the bottom 26. Here, the side member 18b is seated against both the second side wall 24b and the bottom 26 and the mesh material 20 is seated against first retaining wall 24a. Note that the width of side member 18b is substantially less than the depth D of receiving groove 22.

In the groove-attachment screens of the present invention, the side members are made of a material that is stiff enough to provide the screen with sufficient rigidity to retain the screen in the window or door opening under normal environmental conditions. Suitable materials include, without limitation, metals (e.g., steel, stainless steel, aluminum, bronze, copper, brass), polymers, fiberglass, and wood. The overall frame is sized to fit the opening in which the screen is intended to be used. Preferably, the frame will be sized so that when the screen is in place in its intended door or window opening, each of the side members will seat against the respective adjacent side of the door or window opening with some amount of elastic force being provided by the frame against the sides of the opening. However, looser fits of the screen within the intended opening are also within the scope of the present invention.

The mesh material in the groove-attachment screens of the present invention may be any mesh material that is compatible with the environment in which the screen is to be used and with the frame materials and the manner or materials by which the mesh material is to be attached to the frame. Preferably, the mesh material is a light-weight material and/or one that provides good passage of air and light without being distracting to a person who is attempting to look through the screen material. Despite these preferences, any mesh materials meeting the above-stated compatibility criteria are within the scope of the present invention. Suitable mesh materials include, without limitation, those made from fiberglass, polymers, and metals (e.g., aluminum, steel, stainless steel, brass, bronze, and copper). The size of the mesh may be selected based upon the amount of airflow and the size of the insects, debris, etc., that the screen is intended to exclude.

In the present invention, the mesh material is fixedly attached to the frame material. This means that, once attached to each other, the relative positions of the mesh material and the frame material do not change at their attachment points or areas. The means of attachment is selected so that it is compatible with the mesh material and the frame material taking into consideration the environment in which the screen is to be used. Suitable means of attachment include, without limitation, welds, adhesives, and mechanical fasteners. The mesh material may be sized to fit against a face of the frame or it may be sized to wrap partially or completely around one or more of the side members. The mesh material may also be sized so as to cover both sides of the frame aperture.

Two parallel side members of the screens of the present invention are adapted to fit within respective parallel full or partial receiving grooves of the door or window opening. It is preferred that the side members have widths that are less than or equal to the depths of the receiving grooves into which they are received. This condition renders a side member invisible to an observer who is viewing the screen with a line of vision that is perpendicular to the screen's mesh material surface. However, the present invention also includes embodiments having one or more side members that are wider than the depth of the relevant receiving grooves. In some embodiments, the mesh material wraps around one or more of the side members. In such embodiments, the amount of space that will be taken up by the mesh material also must be taken into account in adapting a side member to fit within a receiving groove. It is preferred that the side member with its mesh material fit snugly in the relevant receiving groove to prevent the screen from rattling. However, looser fits are also within the scope of the present invention. In some preferred embodiments of the present invention, one or both of the side members that are received into the receiving grooves have widths that are no more than about 0.75 inches.

At least one of the side members which are to be received within a receiving groove is made of a elastic material and dimensioned so as to have a transverse width-to-thickness ratio of no more than about 1.5, and preferably no more than about 1. This combination of features permits the side member to be urged inward toward the frame's aperture and facilitates the installation and removal of the screen from the door or window opening. Preferably, two, three, or all of the side members have such features so as to further facilitate such installation and removal. Also preferably, the side member or side members having the features stated at the opening sentence of this paragraph are capable of bowing sufficiently into the frame aperture when a perpendicular force is applied to the mesh material adjacent to the side member, the amount of bowing being sufficient to permit a person to grasp the side member with his or her hand and then to bow further into the aperture upon the application of a lateral force to the side member, i.e., a force directed into the aperture, an amount sufficient to permit the side member to be removed from its respective receiving groove.

As for the side members of the groove-attachment screens of the present invention which interconnect the side members that are received in the receiving grooves of the door or window openings, it is preferred that these side members also are made of a elastic material and dimensioned so as to have a transverse width-to-thickness ratio of no more than about 1.5, and more preferably no more than about 1. It is also preferred that at these side members have widths that are no more than about 0.75 inches. However, it is to be understood, that such side members that are not elastic and/or have width-to-thickness ratios greater than about 1.5 and/or have widths of greater than about 0.75 inches are within the scope of the present invention.

It is to be understood that although the side members are depicted in the drawing as having rectangular transverse cross-sectional shapes, the side member cross-sectional shape may take on any configuration and may even change from shape to shape along the length of the side member. When non-rectangular cross-sectional shapes are used, the width of the cross-section is to be defined as the dimension that is parallel to the plane of the mesh material and the thickness as the dimension that is perpendicular to the plane of the mesh material.

It is also to be understood that although the side members are depicted in the drawings to be continuous from end to end, a side member may be made of component pieces and the components pieces may be made of the same or different materials from one another. Also, it is to be understood that the individual side members of the frame may be interconnected discrete pieces or they may be combined so that one piece constitutes more than one side member or even the entire frame. Connections, whether they are between component parts of an individual side member or between any other components of the frame, may be made by any known means, including without limitation, welds, adhesives, and mechanical fasteners or any combination thereof.

The preferred methods of installing the groove-attachment screens of the present invention vary depending upon how many of the side members of the particular screen have the features of being made of a elastic material and dimensioned so as to have a transverse width-to-thickness ratio of no more than about 1.5, and preferably no more than about 1. For an embodiment having just one such side member (the “featured side member”), the preferred method of installation is as follows. First, the screen is angled so as to seat the side member which is parallel to the featured side member into its respective receiving groove. Then, as the screen is rotated into the plane defined by the parallel receiving grooves of the door or window opening, a lateral force is applied to the featured side causing it to bow into the frame aperture so that the featured side is able to slip by the lip of its receiving groove. The force is then relieved allowing the featured side to move into its receiving groove. Removal of the screen may be accomplished by applying an outwardly directed force against the mesh material so as to cause the featured side to bow into the frame aperture. The featured side is then grasped and a lateral force is applied to it so as to bow it out of its receiving groove. The screen is then rotated and the side member that is parallel to the featured side member is then pulled out of its receiving groove.

In embodiments of the present invention having two parallel featured side members, a preferred method of installation is to apply lateral forces to bow both of the side members into the frame aperture, position the screen against the door or window opening, and then to release the featured sides so that they enter into their respective receiving grooves. A preferred method of removal is the same as described above for the embodiments having only a single featured side member.

In embodiments of the present invention having one or more optional tabs attached to the screen frame, the tab or tabs may be used to grasp the side members in the installation and removal of the screens. Preferably, the tabs are attached to a featured side and can be used to grasp the featured side during a bowing step. The tabs are dimensioned to be of a size that can be hand grasped and constructed of materials that provide sufficient strength for the bowing step. The shape, size, and construction of a tab are only constrained by the requirement that the tab be capable of carrying out the functional considerations identified in the previous sentence. A tab may be attached by any known means to the side member.

In the embodiments of the present invention shown in the drawings, the groove-attachment screens have two sets of parallel sides. It is to be understood, however, that the present invention also includes embodiments in which one or two of the sides members are arched. Also, in the embodiments of the present invention shown in the drawings, the corners of the frame are square. However, it is to be understood that the present invention includes within its scope embodiments in which one or more of the junctions of the side members are at angles other than right angles and/or are rounded.

While only a few embodiments of the present invention have been shown and described, it will be obvious to those skilled in the art that many changes and modifications may be made thereunto without departing from the spirit and scope of the present invention as described in the following claims. All patent applications, patents, and all other publications referenced herein are incorporated herein in their entireties to the full extent permitted by law.

What is claimed is:

1. A groove-attachment screen adapted to be retained within two parallel receiving grooves of a door or window opening, the screen comprising a frame forming an aperture and a mesh material, the mesh material being fixedly attached to the frame so as cover the aperture, the frame having a pair of first side members each of which is adapted to be received within a respective one of the receiving grooves, at least one of the first side members comprising an elastic material and having a transverse width-to-thickness ratio of no more than about 1.5.

2. The groove-attachment screen of claim 1, wherein the at least one side member is capable of bowing sufficiently into the aperture when a force is applied perpendicularly against the mesh material adjacent to that first side member to permit that first side member to be grasped by a person's hand and to bow sufficiently further into the aperture upon the application of a lateral force to that first side member to cause that first side member to withdraw from its respective receiving groove.

3. The groove-attachment screen of claim 1, wherein the at least one of the first side members has a transverse width-to-thickness ratio of no more than about 1.

4. The groove-attachment screen of claim 1, wherein at least one of the first side members has a width that is that less than the depth of its respective receiving groove.

5. The groove-attachment screen of claim 1, wherein the at least one of the first side member has a width that is no more than about 0.75 inches.

6. The groove-attachment screen of claim 1, wherein both of the side members have widths of no more than about 0.75 inches.

7. The groove-attachment screen of claim 1, wherein the frame also comprises at least one second side member which interconnects the pair of first side members, the second side member having a transverse width-to-thickness ratio of no more than about 1.5.

8. The groove-attachment screen of claim 6, wherein the at least one second side member has a width of no more than about 0.75 inches.

9. The groove-attachment screen of claim 1, further comprising a tab attached to the at least one first side member, the tab being of a size and construction to be grasped by a user's hand to urge that first side member in the direction of the aperture.

10. The groove-attachment screen of claim 1, wherein the frame also comprises a pair of second side members each of which interconnects the pair of first side members.

11. The groove-attachment screen of claim 10, wherein at least one of the second side members has a transverse width-to-thickness ratio of no more than about 1.5.

12. The groove-attachment screen of claim 10, wherein at least one of the second side members has a transverse width-to-thickness ratio of no more than about 1.

13. The groove-attachment screen of claim 10, wherein at least one of the second side members has a width of no more than about 0.75 inches.

14. The groove-attachment screen of claim 1, wherein the frame also comprises at least one second side member which interconnects the pair of first side members, the second side member having a normally arched configuration.
